(19) United States
(12) Patent Application Publication
(10) Pub. No.: US 2012/0027559 A1
(43) Pub. Date: Feb. 2, 2012

(54) TOOL AND METHOD FOR LIFTING AND DRAGGING HEAVY LOADS

(76) Inventors: Bruno Farbos, Montreal (CA); Daniel Imbeau, Montreal (CA)

(21) Appl. No.: 13/133,783

(22) PCT Filed: Dec. 9, 2009
(86) PCT No.: PCT/CA2009/001796

§ 371 Date: Jun. 9, 2011

Related U.S. Application Data
(63) Continuation of application No. 12/330,938, filed on Dec. 9, 2008, now abandoned.

(51) Int. Cl. B65G 7/02; B66F 15/00

(52) U.S. Cl. 414/800; 254/119

(57) ABSTRACT

The present document describes a user-operated tool and a method for lifting and dragging a heavy load on a surface. The tool comprises an elongated body having an upper end comprising a grip, a lower end for making contact with the surface in the vicinity of the heavy load, and a flex point located between the upper end and the lower end. The tool comprising a lift and drag member, having a hook member for hooking to the heavy load, connected to the elongated body and is movable about the flex point. The tool comprising a strap reel fixed on the elongated body for winding the strap thereon. In use, the user grips the tool and rotates the elongated member about the lower end and away from the heavy load. The lift and drag member thereby first lifts and then drags the heavy load toward the lower end.

### TECHNICAL FIELD

This description relates to the field of hand-operated tools. More particularly, this description relates to manual tools for handling heavy loads.

### BACKGROUND OF THE INVENTION

The prior art discloses tools and methods for lifting and dragging heavy loads such as manhole covers or the like for which the user must bent down during its operation. In other tools and methods, the user is stand up, but must adopt poor ergonomic positions. An ergonomic position aims to keep the back of the user substantially straight and vertical and to keep the forearms substantially horizontal, or slightly below horizontal, while keeping both hands at the same level. Furthermore, there is a need for a tool comprising a safety base for gripping the surface to avoid slippage and to prevent an incorrect movement or a wrong posture of the user.

### SUMMARY OF THE INVENTION

According to an aspect of the invention, there is provided a user-operated tool for lifting and dragging a heavy load on a surface. The tool comprises an elongated body having an upper end, a lower end, and a flex point located between the upper end and the lower end. The lower end is for making contact with the surface in the vicinity of the heavy load. The upper end comprises a right grip and a left grip disposed on the elongated body. The tool further comprises a lift and drag member connected to the elongated body. The lift and drag member is movable about the flex point. The lift and drag member comprises a hook member for hooking to the heavy load. In use, the user grips the left and right grips with his left and right hands respectively, his hands being at an equal distance from the surface, while keeping his forearms substantially horizontal and his back straight and substantially vertical. The user rotates the elongated member around the lower end and away from the heavy load. The lift and drag member thereby first lifts and then drags the heavy load toward the lower end.

According to another aspect of the invention, there is provided an ergonomic method for lifting and dragging a heavy load on a surface by a user. The method comprises: providing a hand-operated tool having a lower end and an upper end, the upper end comprising a left grip and a right grip; resting the lower end on the surface in the vicinity of the heavy load; hooking the hook member to the heavy load; positioning the hand-operated tool such that the user, with his back straight and substantially vertical, can grip the left and right grips with his left and right hands respectively, his hands being at an equal distance from the surface, while keeping his forearms substantially horizontal; gripping the left and right grips with his left and right hands respectively; and rotating the elongated member around the lower end and away from the heavy load, thereby first lifting and then dragging the heavy load on the surface.

According to another aspect of the invention, there is provided a user-operated tool for lifting and dragging a heavy load on a surface. The tool comprises an elongated body having an upper end, a lower end, and a flex point located between the upper end and the lower end. The upper end comprises a grip disposed on the elongated body. The tool further comprises a sole pivotally coupled to the lower end, the sole comprising a first gripping portion and a second gripping portion. The first gripping portion is for making contact with the surface and is adapted to grip a type of surface and the second gripping portion is for making contact with the surface and is adapted to grip another type of surface. The tool further comprises a lift and drag member connected to the elongated body. The lift and drag member is movable about the flex point. The lift and drag member comprise a hook member for hooking to the heavy load. In use, the user selects one of the first gripping portion and the second gripping portion for making contact with the surface by rotation of the sole with respect to the elongated body, then the user grips the grip with at least one of his hands and the user rotates the elongated body around the sole and away from the heavy load. The lift and drag member thereby first lifts and then drags the heavy load toward the sole.

### BRIEF DESCRIPTION OF THE DRAWINGS

Further features and advantages of the present invention will become apparent from the following detailed description, taken in combination with the appended drawings, in which:

FIG. 1 is a perspective view illustrating a tool, in accordance with an embodiment of the invention;

FIG. 2 is an exploded view of the tool of FIG. 1;

FIG. 3a is top view of the tool of FIG. 1;

FIG. 3b is a front elevation of the tool of FIG. 1;

FIG. 3c is a side elevation of the tool of FIG. 1;

FIG. 4a is a side elevation of the tool of FIG. 1 in use before lifting a heavy load and gripped by a normal user;

FIG. 4b is a side elevation of the tool of FIG. 1 in use before lifting an heavy load and gripped by a small user;

FIG. 4c is a side elevation of the tool of FIG. 1 in use before lifting an heavy load and gripped by a tall user;

FIG. 5 is a side elevation of the tool of FIG. 1 in use after lifting and dragging the heavy load and gripped by the tall user;

FIG. 6 is a flowchart showing a method for lifting and dragging a heavy load according to an embodiment of the invention;

FIG. 7a and FIG. 7b are detailed perspective views of the lower end of the tool according to another embodiment of the invention; and

FIG. 8 is a perspective view illustrating a tool, in accordance with another embodiment of the invention;

It will be noted that throughout the appended drawings, like features are identified by like reference numerals.

### DETAILED DESCRIPTION

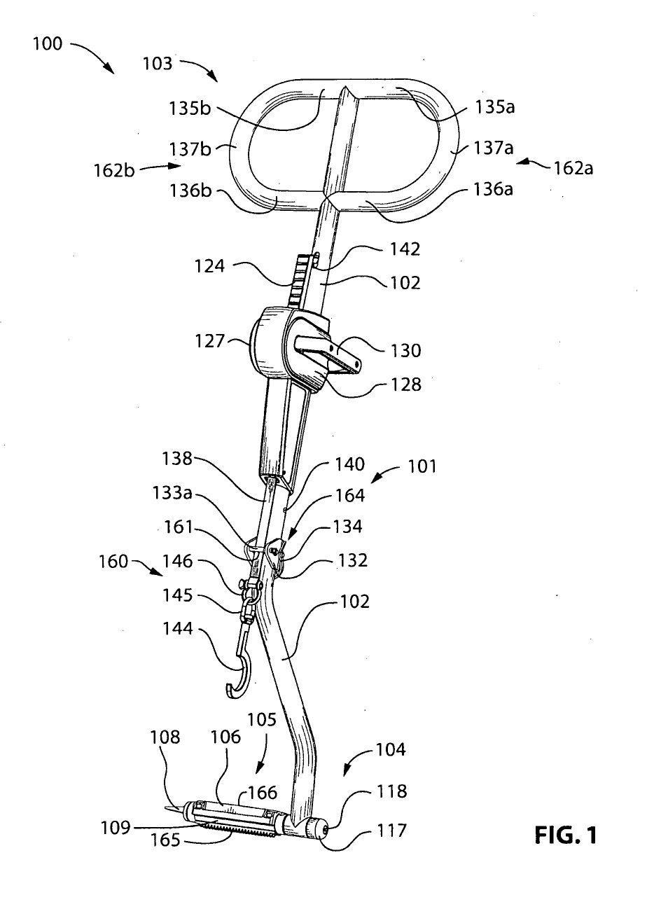

Referring now to the drawings, and more particularly to FIGS. 1, 2 and 3a-b-c, there is shown a tool 100 according to an embodiment of the invention. The tool 100 is mainly made of an elongated body 101 and a lift and drag member 160. The elongated body 101 comprises an upper end 103 and a lower end 104, the lower end 104 for making contact with a surface, not shown. The upper end 103 comprises a right grip e.g. 137b and a left grip e.g. 137a, forming a grip, not numbered, for manipulating the tool 100. The lift and drag member 160 is connected to the elongated body 101 at a flex point 161 located between the upper end 103 and the lower end 104. The lift and drag member 160, movable about the flex point 161, comprises a hook member 144 for hooking to a heavy load, not shown, such as manhole covers or the like.

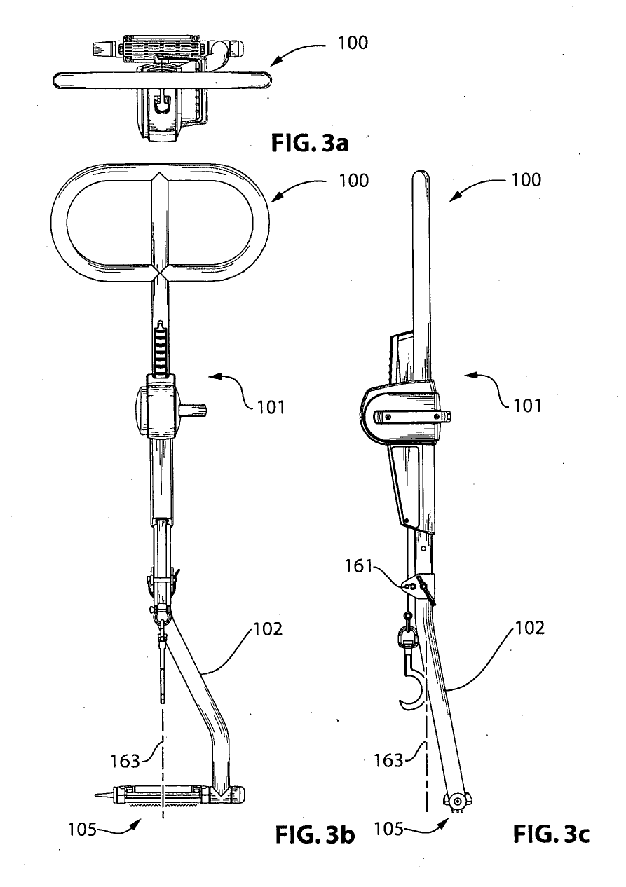

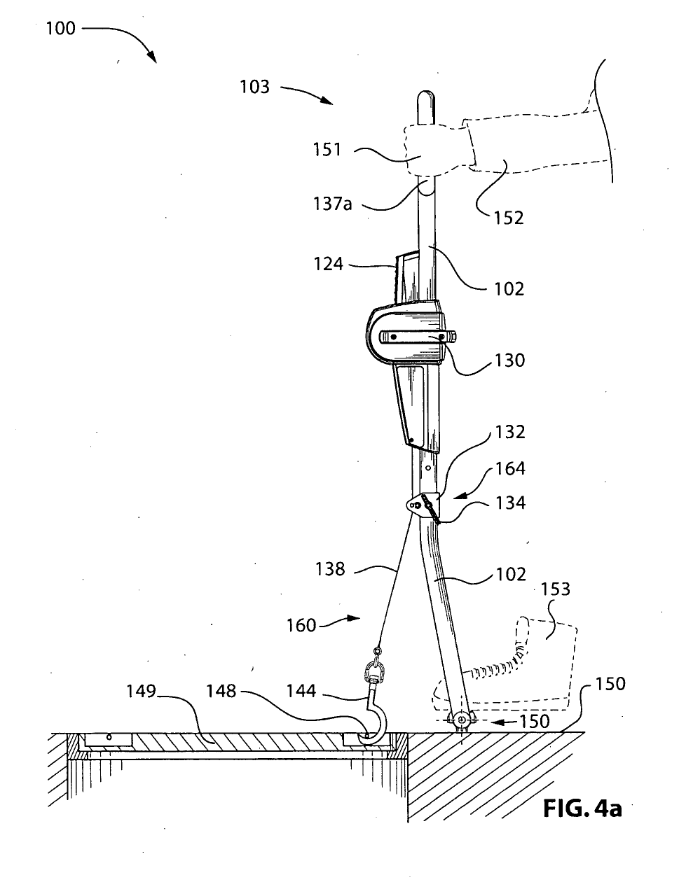

The upper end 103 and the lower end 104 are firmly connected by a tube 102 offering a fold resistance. In the lower part of the elongated body 101, the tube 102 is arched according to two plans. In a first plan, shown on FIG. 3b, the tube 102 is arched for projecting a longitudinal axis 163 of the upper part of the elongated body 101 to the middle of the sole 105, thereby freeing a space for receiving a foot of a user in the longitudinal axis 163. In a second plan, shown on FIG. 3c, the tube 102 is arched for taking the projection of the flex point 161 according the longitudinal axis 163 away from the sole 105. A person skilled in the art will understand that the tube 102 can be replaced by another beam having a portion made of metal bar, truss, plastic, composite material, wood or the like and replace such arched beam by a straight beam or by a beam differently arched.

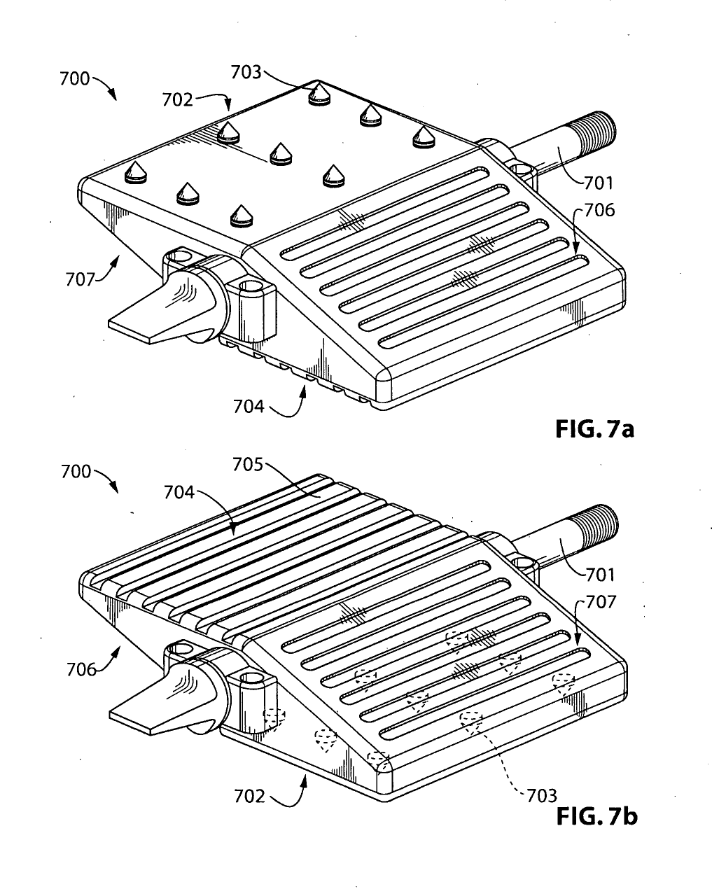

At the lower end 104, a shaft 110 perpendicularly crosses the tube 102 and is fixed longitudinally to the tube 102 with a nut 116 screwed on one end of the shaft 110. The nut 116 interfaces with the tube 102 by washers 114-115. A cap 117 is screwed in the shaft 110 by a screw 118 for hiding the nut 116. The shaft 110 is rotationally fixed to the tube 102 by a screw 111, screwed in the tube 102 and pressing against the shaft 110. A ground part 109 and a foot part 106 are screwed together by screws 113a-b-c-d around the shaft 110 forming a sole 105. The sole 105 is free to rotate around the shaft 110. The ground part 109, being for making contact with the surface, has an external grooved first gripping face 165 for preventing the sole 105 from slipping on the surface. The foot part 106 being for receiving a foot of the user has a second gripping face 166 for preventing the foot from slipping. A person skilled in the art could easily replace the rotatable sole 105 by a fixed sole, a peg lightly drivable through the surface or a sole as described on FIGS. 7a and 7b.

At the other end of the shaft 110, a peg 108 is inserted in the shaft 110 and blocked by a screw 112 screwed in the shaft 110 and pressing against the peg 108. The peg 108 is notably used for cleaning a receptacle of the heavy load thereby making easier the further lifting of the heavy load. A person skilled in the art could easily replace the peg 108 by another peg tool, e.g., a pick or a blade, or by a cleaning tool, e.g., a brush or by a locking-unlocking tool thus permitting to lock and unlock the heavy load in the receptacle or by any other useful tool. A person skilled in the art could also easily set a peg tool, a cleaning tool, a locking-unlocking tool or any other useful tool at another appropriated location on the tool 100.

The upper end 103 comprises a right handle 162b and a left handle 162a, each U-shaped and symmetrically disposed, by its two ends, on the elongated body 101. Each handle has an upper grip 135a-b, a lower grip 136a-b and a middle grip 137a-b. Circulating continuously along each handle 162a-b between the upper grip 135a-b and the lower grip 136a-b, at any location, can be defined a right grip and a left grip fitted to the size of the user. Other embodiments for the right handle 162b and the left handle 162a are discussed below.

According to another embodiment, not shown, the upper end 103 comprises a right handle and a left handle connected to the elongated body 101 offering a plurality of right grips and left grips at a plurality of distances from the lower end 104.

Another embodiment, not shown, could comprise a right handle and a left handle connected to the elongated body 101, each handle having a plurality of branches, each right branch and left branch respectively having a right grip and a left grip.

Another embodiment, not shown, could comprise a right handle and a left handle connected to the elongated body 101, each handle having respectively a right grip and a left grip, the right handle and the left handle having an adjustable position along the elongated body 101, thus offering a right grip and a left grip whose the distance from the lower end 104 can vary.

Another embodiment, not shown, could comprise a right handle and a left handle connected to the elongated body 101 and made of rigid material, e.g. metal, plastic, composite, wood, etc., or flexible material, e.g. strap, chain, cable, string, wire, etc. It is understood that combinations of these previous embodiments are possible.

Returning now to the embodiment 100 of the invention shown on FIGS. 1, 2 and 3a-b-c, there is shown the lift and drag member 160 mainly made of a strap 138. The strap 138 is connected to the elongated body 101 by a strap reel 119 and by a guide 164 defining the flex point 161. The lift and drag member 160 can move about the flex point 161. At the outer end of the strap 138, the hook member 144 is attached via a ring 145 and a removable shackle 146 allowing the hook member 144 to pivot. A person skilled in the art could easily design several embodiments, not shown, of hook members fitted to the heavy load, such as a fitted hook, a versatile hook, a key, a fastener, a magnetic attachment or the like. Other embodiments for the lift and drag member 160 connected to the elongated body 101 are discussed below.

Another embodiment, not shown, comprises a lift and drag member having a portion made of tube, metal bar, truss, plastic, composite material, wood, chain, cable, string, wire or the like.

Another embodiment, not shown, comprises a lift and drag member having a length adapter for varying the length of the lift and drag member and thereby adapting the tool according to the heavy load and the surface. In this embodiment, the length adapter includes a continuous adapter by screwing, by sliding with continuous stopper or by winding or could be a discontinuous adapter by fastening at specific locations.

Another embodiment, not shown, comprises a pivoting means for pivoting the lift and drag member around the flex point, the pivoting means connected to the elongated body and comprising a pivot, a flexible material or the like.

Another embodiment, not shown, comprises a displacing means for displacing the pivoting means along the elongated body and thereby for displacing the flex point on the elongated body. The displacing means could comprise a continuous controller like a slide with a continuous stopper, a discontinuous controller like a fastener able to fasten at specific location on the elongated body or the like.

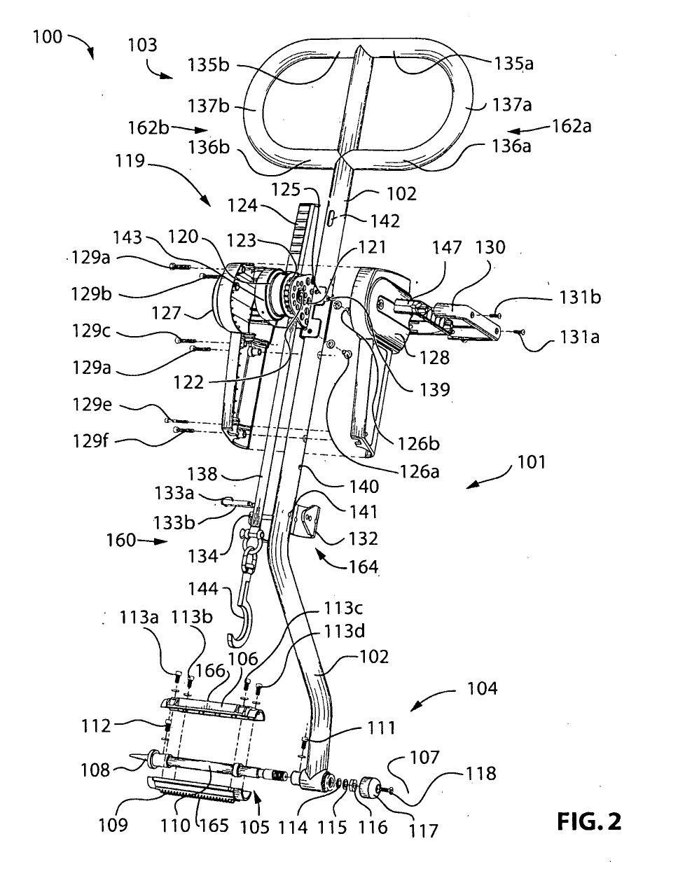

Returning now to the embodiment 100 of the invention on FIG. 2, there is detailed the strap reel 119 located below the upper end 103. A lug 125 is welded to the tube 102 for receiving a U-shaped base 121 fixed to the lug 125 by screws 126a-b passing through the tube 102 and through the lug 125. A wheel 120 and a united ratchet 123 are pivotally coupled to the U-shaped base 121 around a pivot 122. The strap 138 is winded on the wheel 120. A spiral spring 143 takes base on the U-shaped base 121 for biasing the strap 138 to wind around the wheel 120. A lever 124 operates a dispensing mechanism, not shown.

The lever 124 has a stable position along the tube 102. In this stable position, the dispensing mechanism blocks the wheel 120 preventing the strap 138 from winding on the wheel 120 and firmly preventing the strap 138 from unwinding from the wheel 120 using the ratchet 123. The lever 124 has an unstable adjusting position when a user squeezes the handle 124 toward the tube 102. Then, the end of the lever 124 enters in the tube 102 through a hole 142. The adjusting position is an unstable position. That means that to maintain the adjusting position the user needs to maintain a pressure on the lever 124. In this position, the strap 138 can be wound or unwound according to the need of the user. Thereby, the user can adjust the length of the strap 138 for operating the tool according to the heavy loads to be dragged, the environment and his liking.

Two parts of a cover 127-128 are screwed together around the strap reel 119 and around the tube 102 by screws 129a-b-c-d-e-f. The cover 127-128 is for hiding the strap reel 119, preventing user from injury and protecting the mechanism from excessive dust. On part 128 of the cover, there are a secondary handle 147 screwed on and a handle cover 130 screwed on the secondary handle 147 by screws 131a-b. The secondary handle 147 is useful for transporting the tool between a storage location and a utilization location. For comfort purposes, the secondary handle 147 is located near the center of gravity of the tool. The secondary handle is particularly well oriented for using the peg 108, one hand gripping the secondary handle 147, the other hand gripping the left handle 162a.

According to another embodiment, the above described mechanism can be replaced by another mechanism like an automotive belt which allows blocking the wheel by pulling a blow on the strap. Also, the strap reel 119 can be replaced by a fixed fastener for fixing the end of the strap 138 to the elongated body 101, at a specific location or at several possible location for varying the length of the lift and drag member.

Returning now to the embodiment 100 of the invention on FIG. 2, there is detailed the guide 119 located between the upper end 103 and the lower end 103. A U-shaped lug 132 bestrides the tube 102 and is fastened to the tube 102 by a fastener 134 passing through the U-shaped lug 132 and passing through the tube 102 by a hole 141. Two rollers 133a,b are held by the U-shaped lug 132 and can roll for guiding the strap 138 passing between the two rollers 133a,b. The two rollers 133a,b and the U-shaped lug 132 form a guiding means which fixes the distance of the strap 138 to the elongated body 101 at a point where the rollers 133a,b are located. The guiding means forces the strap 138 to flex in a given location, thereby defining a flex point. A displacing means allows the guiding means to displace along the elongated member 101 thereby displacing the flex point on the elongated body 101. The displacing means allows two positions along the elongated body 101, one at the hole 141, another at hole 140.

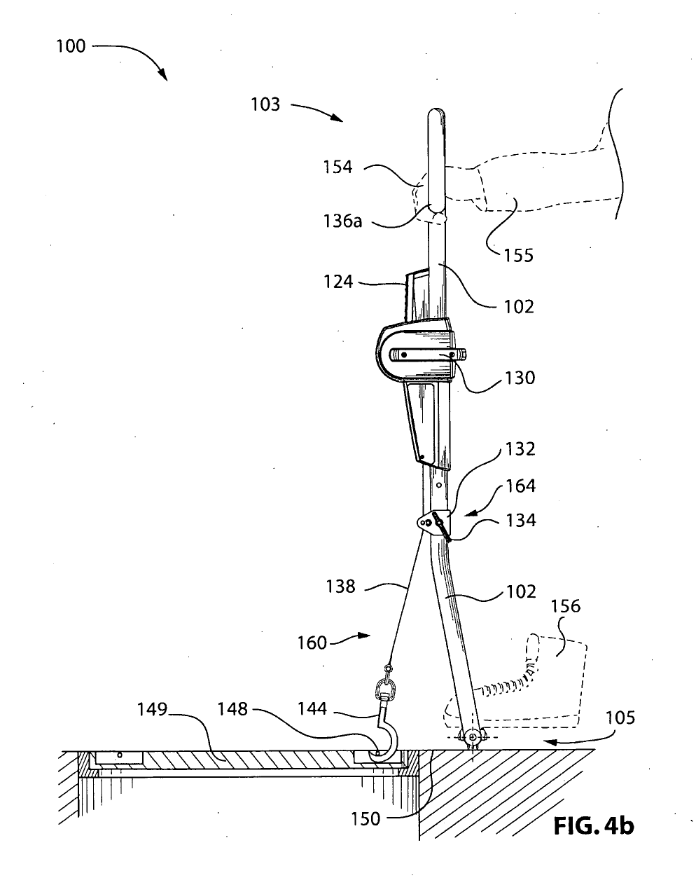

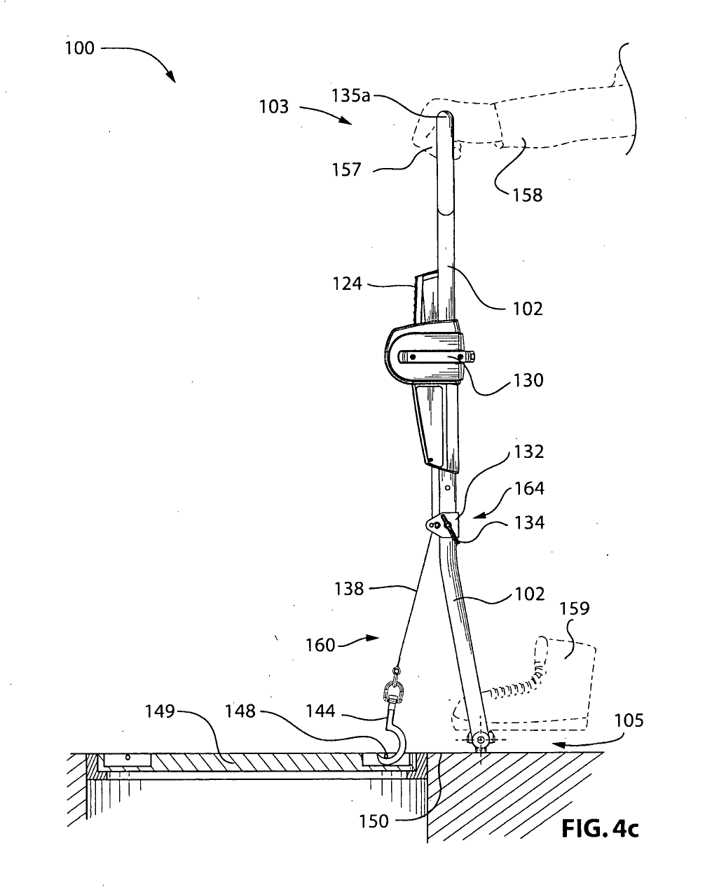

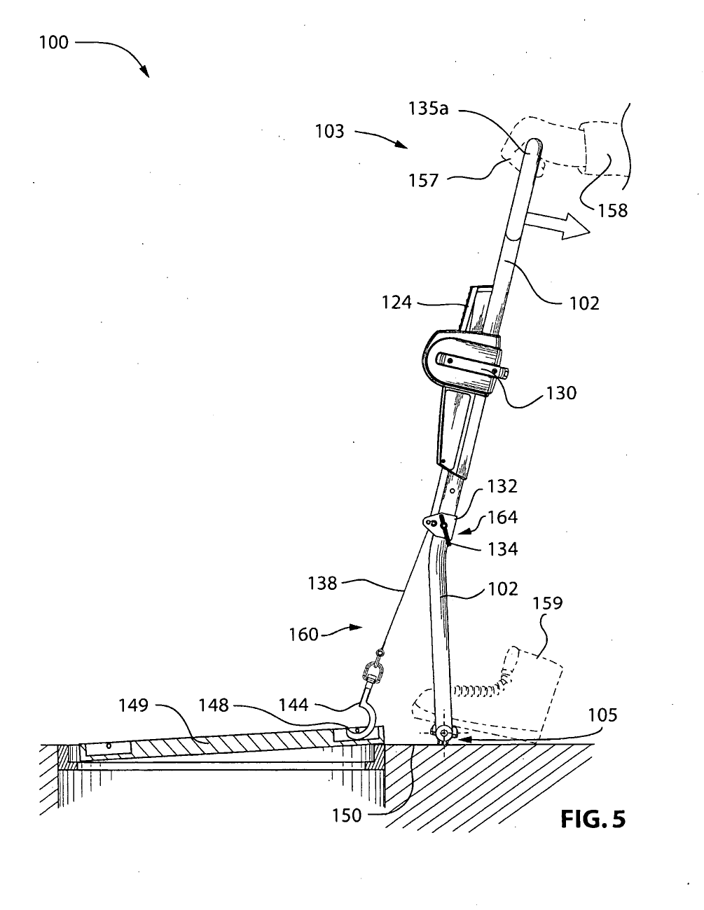

Now referring to FIG. 4a, there is shown the tool 100 in a use position. The sole 105 is rested on the surface 150 in the vicinity of the manhole cover 149. A normal user steps on the sole 105 with his foot 153. Thereby the sole 105 is pressed on the surface 150, thus creating a fulcrum with respect to the surface for the tool 100 and thus reinforcing the immobilization of the fulcrum and offering it to the user.

The hook member 144 is hooked to a hook point 148 of the manhole cover 149. The elongated body 101 is raised and, using the lever 124, the length of the strap 138 is adjusted for being fairly tense. The level of the guide 164 is previously fixed with the fastener 134.

The normal user chooses a right grip and a left grip, both at the same distance from the surface 150, adapted such that when the user grips the left grip 137a and right grip, not shown, with his left hand 151 and right hand, not shown, respectively, his hands 151 are at an equal distance from the surface 150, while keeping his forearms 152 substantially horizontal and his back straight and substantially vertical. In this case the left grip 137a is located on the vertical portion of the left handle 162a.

Now referring to FIG. 4b, there is shown the tool 100 in the same configuration as on FIG. 4a. A small user replaces the normal user. The small user chooses a right grip and a left grip, both at the same distance from the surface 150, adapted such that when the user grips the left grip 136a and right grip, not shown, with his left hand 154 and right hand, not shown, respectively, his hands 154 are at an equal distance from the surface 150, while keeping his forearms 155 substantially horizontal and his back straight and substantially vertical. In this case the left grip 136a is located on the lower portion of the left handle 162a.

Now referring to FIG. 4c, there is shown the tool 100 in the same configuration than on FIG. 4a. A tall user replaces the normal user. The tall user chooses a right grip and a left grip, both at the same distance from the surface 150, adapted such that when the user grips the left grip 135a and right grip, not shown, with his left hand 157 and right hand, not shown, respectively, his hands 157 are at an equal distance from the surface 150, while keeping his forearms 158 substantially horizontal and his back straight and substantially vertical In this case, the left grip is located on the upper portion of the left handle 162a.

Now referring to FIG. 5, there is shown the tool 100 used by the tall user. The tall user has already pulled on the left grip 135a and the right grip, not shown, toward him and thus rotated the elongated body including the tube 102 around the lower end including the sole 105 and away from the heavy load 149, the lift and drag member 160 thereby first lifts and then drags the heavy load 149 toward the lower end including the sole 105. To drag the cover 149 off the manhole, the tall user has to release his foot 159 from the sole 105, move the sole 105 away from the manhole cover 149, squeezing the handle 124 to the tube 102 for extending the strap 138, step again on the sole 105 and pull again on the left grip 135a and the right grip.

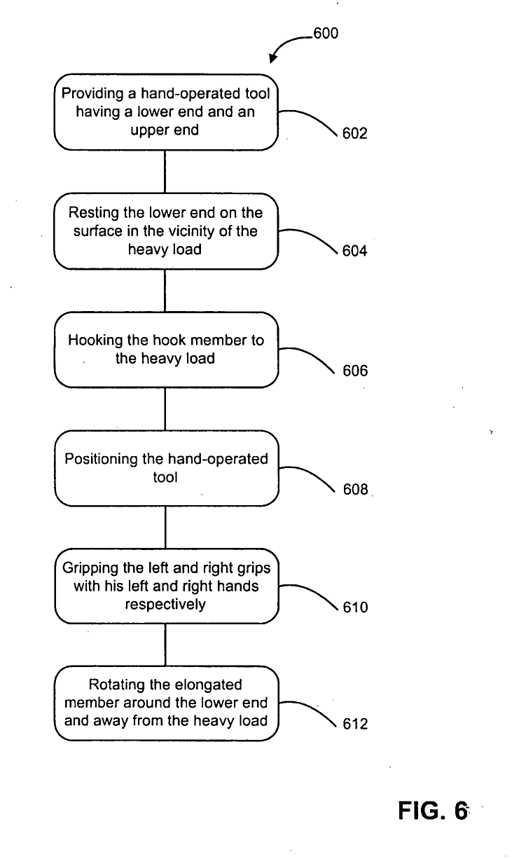

Now referring to FIG. 6, there is shown a flowchart of a method 600 for lifting and dragging a heavy load according to an embodiment of the invention. Method 600 comprises: providing a hand-operated tool having a lower end and an upper end (step 602), the upper end comprising a left grip and a right grip; resting the lower end on the surface in the vicinity of the heavy load (step 604); hooking the hook member to the heavy load (step 606); positioning the hand-operated tool such that the user, with his back straight and substantially vertical, can grip the left and right grips with his left and right hands respectively, his hands being at an equal distance from the surface, while keeping his forearms substantially horizontal (step 608); gripping the left and right grips with his left and right hands respectively (step 610); and rotating the elongated member around the lower end and away from the heavy load, thereby first lifting and then dragging the heavy load on the surface (step 612).

In the method 600, wherein the lower end optionally comprises a sole having a first gripping portion and a second gripping portion, the sole is optionally pivotally coupled to the hand-operated tool. Optionally, the method 600 further comprises selecting one of the first gripping portion and the second gripping portion for making contact with the surface by rotation of the sole with respect to the hand-operated tool, not shown.

Optionally, the method 600, wherein the sole optionally further having a foot portion, further comprises applying a force on the foot portion by a user's foot, for transmitting a portion of the force to the selected of the first gripping portion and the second gripping portion toward the surface for gripping the surface, not shown.

Now referring to FIG. 7a and FIG. 7b, there is shown a sole 700 according to another embodiment of the invention having two positions in use. The sole 700 is pivotally coupled to a shaft 701. The shaft is an extension of the tool. The sole 700 comprises a first gripping portion 702 for making contact to a surface, not shown. The first gripping portion 702 comprises a plurality of pegs 703 protruding outwardly from the first gripping portion 702 being thus adapted for gripping a type of surface such as ice or snow. On the opposite side, the sole 700 further comprises a second gripping portion 704 for making contact to another surface, not shown. The second gripping portion 704 comprises a rubber grooved plate 705, namely an anti-slipping plate, making the second gripping portion 704 adapted for gripping another type of surface such as concrete, bitumen or cast steel without damaging the surface. The rotation of the sole 700 makes possible the designing of large areas for making contact with surfaces that decreases a chance the sole slips with respect to the surface.

The sole 700 further comprises a first foot portion 706 and a second foot portion 707 opposite the first foot portion 706. Referring to FIG. 7a, there is shown the sole 700 in a first position, the second gripping portion 704 being selected for making contact to a surface, not shown, and the first foot portion 706 being located on the top of the sole 700 for interfacing with a user's foot applying a first force on the first foot portion 706 and for transmitting a portion of the first force to the second gripping portion 704 toward the surface.

Referring to FIG. 7b, there is shown the sole 700 in a second position, the first gripping portion 702 being selected for making contact to a surface, not shown, and the second foot portion 707 being located on the top of the sole 700 for interfacing with a user's foot applying a first force on the second foot portion 707 and for transmitting a portion of the first force to the first gripping portion 702 toward the surface.

A tool having such a sole 700, offering a large and adapted area for making contact with a surface and permitting to apply a force toward the surface, makes it more comfortable and more secure for a user. It is understood that a person skilled in the art could easily replace the pegs 703 or the rubber grooved plate 705 with others components such as notched sheet metal.

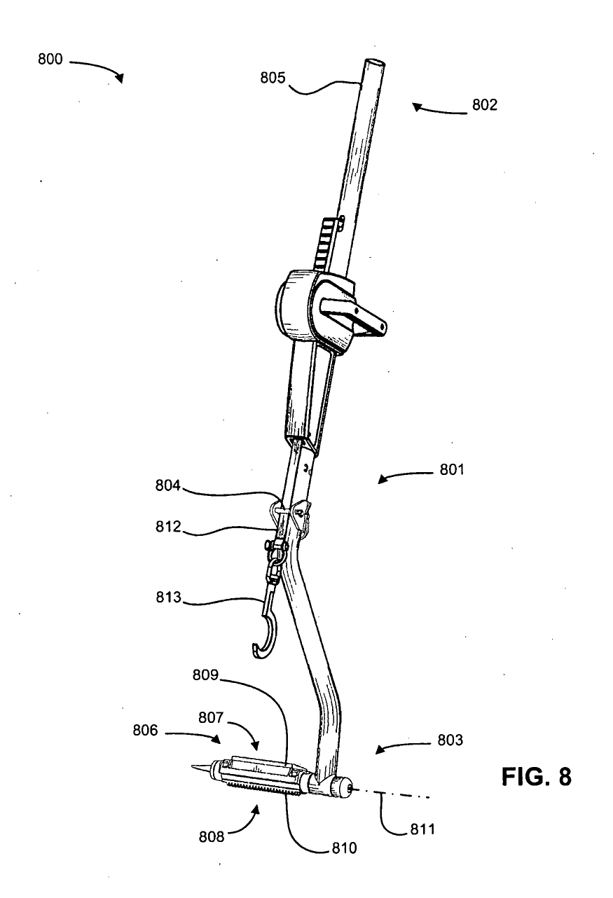

Now referring to FIG. 8, there is shown a tool 800 for lifting and dragging a heavy load on a surface, not shown. The tool 800 comprises an elongated body 801 having an upper end 802, a lower end 803, and a flex point 804 located between the upper end 802 and the lower end 803. The upper end 802 comprises a grip 805 disposed on the elongated body 801. The tool 800 further comprises a sole 806 pivotally coupled to the lower end 803.

The sole 806 comprises a first gripping portion 807 and a second gripping portion 808, the first gripping portion 807 being for making contact with the surface and adapted to grip a type of surface and the second gripping portion 808 being for making contact with the surface and adapted to grip another type of surface. The first gripping portion 807 comprises a rubber plate 809, namely an anti-slipping plate, making the first gripping portion 807 adapted for gripping a type of surface such as concrete, bitumen or cast steel without damaging the surface. At the opposite according to the axis 811, the second gripping portion 808 comprises a plurality of pegs 810 protruded outwardly from the second gripping portion 808 being thus adapted for gripping a type of surface such as ice or snow. The rotation of the sole 806 makes possible a designing of large areas for making contact with surfaces that decreases a chance the sole slips with respect to the surface.

The tool 800 further comprises a lift and drag member 812 connected to the elongated body 801, the lift and drag member 812 being movable about the flex point 804, the lift and drag member 812 comprising a hook member 813 for hooking to the heavy load.

In use, the user selects one of the first gripping portion 807 and the second gripping portion 808 for making contact with the surface by rotation of the sole 806 with respect to the elongated body 80. The user applies a force on the non selected one of the first gripping portion 807 and the second gripping portion 808 with a foot, for transmitting a portion of the force to the selected of the first gripping portion 807 and the second gripping portion 808 toward the surface for gripping the surface. Then, the user grips the grip 805 with at least one of his hands, the user rotates the elongated body 801 around the sole 806 and away from the heavy load, the lift and drag member 812 thereby first lifts and then drags the heavy load toward the sole 806.

While preferred embodiments of the invention have been described above and illustrated in the accompanying drawings, it will be evident to those skilled in the art that modifications may be made therein without departing from the essence of this invention. Such modifications are considered as possible variants comprised in the scope of the invention.

1. A user-operated tool for lifting and dragging a heavy load on a surface, the tool comprising:
an elongated body having an upper end, a lower end, and a flex point located between the upper end and the lower end, the lower end for making contact with the surface in the vicinity of the heavy load, the upper end comprising a right grip and a left grip disposed on the elongated body; and
a lift and drag member connected to the elongated body, the lift and drag member being movable about the flex point, the lift and drag member comprising a hook member for hooking to the heavy load;
whereby, in use, the user grips the left and right grips with his left and right hands respectively, his hands being at an equal distance from the surface, while keeping his forearms substantially horizontal and his back straight and substantially vertical, the user rotates the elongated body around the lower end and away from the heavy load, the lift and drag member thereby first lifts and then drags the heavy load toward the lower end.

2. The tool of claim 1, wherein the upper end comprises a right handle which includes the right grip and a left handle which includes the left grip, each handle being connected to the elongated body.

3. The tool of claim 2, wherein the right handle and the left handle each comprises a U-shape and are symmetrically disposed, by its two ends, on the elongated body.

4. The tool of claim 2, further comprising an adjusting means for adjusting the position of the handles along the elongated body.

5. The tool of claim 2, wherein the right handle and the left handle each comprises at least one of a rigid handle and a flexible handle,

6. The tool of claim 1, wherein the lift and drag member comprises a strap having a body end connected to the elongated body and a hook end, connected to the clinging means.

7. The tool of claim 6, further comprising a guide fixed on the elongated body at the flex point, the guide being for receiving the strap and thereby fixing the distance between the strap and the elongated body.

8. The tool of claim 6, further comprising a strap reel fixed on the elongated body, the strap reel for winding the strap thereon thereby providing a variable length of the strap.

9. The tool of claim 7, wherein the guide comprises a guiding means for receiving the strap and a displacing means for displacing the guiding means along the elongated member thereby displacing the flex point on the elongated body.

10. The tool of claim 1, further comprising a pivoting means connected to the elongated body, the pivoting means for pivoting the lift and drag member around the flex point.

11. The tool of claim 10, further comprising a displacing means for displacing the pivoting means along the elongated member and thereby for displacing the flex point on the elongated body.

12. The tool of claim 1, wherein the lift and drag member comprises a length adapter for varying the length of the lift and drag member and thereby adapting the tool according to the heavy load and the surface.

13. The tool of claim 1, wherein the hook member comprises at least one of a fitted hook, a versatile hook, a key, a fastener, a magnetic attachment.

14. The tool of claim 1, wherein the lower end comprises a sole pivotally coupled to the elongated body, the sole comprising a first gripping face for making contact with the surface and a second gripping face for interfacing with a user's foot.

15. The tool of claim 1, wherein the lower end comprises a sole pivotally coupled to the elongated body, the sole comprising a first gripping portion and a second gripping portion, the first gripping portion for making contact with the surface and being adapted to grip a type of surface and the second gripping portion for making contact with the surface and adapted to grip another type of surface;
wherein, in use, one of the first gripping portion and the second gripping portion is selected for making contact with the surface by rotation of the sole with respect to the elongated body.

16. The tool of claim 15, wherein the sole further comprises a first foot portion and a second foot portion, the first foot portion for interfacing with a user's foot applying a first force on the first foot portion and for transmitting a portion of the first force to the first gripping portion toward the surface, the second foot portion for interfacing with a user's foot applying a second force on the second foot portion and for transmitting a portion of the second force to the second gripping portion toward the surface.

17. The tool of claim 15, wherein each of the first gripping portion and the second gripping portion comprises at least one of an anti-slipping plate, a peg and a notched sheet.

18. The tool of claim 1, further comprising at least one of a cleaning tool, a peg tool and a locking-unlocking tool connected to the tool for assisting the user in his work.

19. An ergonomic method for lifting and dragging a heavy load on a surface by a user, the method comprising:
providing a hand-operated tool having a lower end and an upper end, the upper end comprising a left grip and a right grip;
resting the lower end on the surface in the vicinity of the heavy load;
hooking the hook member to the heavy load;
positioning the hand-operated tool such that the user, with his back straight and substantially vertical, can grip the left and right grips with his left and right hands respectively, his hands being at an equal distance from the surface, while keeping his forearms substantially horizontal;
gripping the left and right grips with his left and right hands respectively; and
rotating the elongated body around the lower end and away from the heavy load, thereby first lifting and then dragging the heavy load on the surface.

20. The method of claim 19, wherein the left and right grips are adjustable or have various positions for the left and right hands, the method further comprising adjusting or selecting the grip position such that the user's forearms are substantially vertical before the rotating, his hands being at an equal distance from the surface, while keeping his forearms substantially horizontal.

21. The method of claim 19, wherein the lower end comprises a sole having a first gripping portion and a second gripping portion, the sole being pivotally coupled to the hand-operated tool, the method further comprising selecting one of the first gripping portion and the second gripping portion for making contact with the surface by rotation of the sole with respect to the hand-operated tool.

22. The method of claim 21, wherein the sole further has a foot portion, the method further comprising applying a force on the foot portion by a user's foot, for transmitting a portion of the force to the selected of the first gripping portion and the second gripping portion toward the surface for gripping the surface.
